(19) United States
(12) Patent Application Publication
(10) Pub. No.: US 2008/0199395 A1
(43) Pub. Date: Aug. 21, 2008

(54) Reversible Hydrogen Storage Composition, Method of Making and Uses of Said Composition

(75) Inventors: Simon Brian Dodd, Hampshire (GB); Susan Morris, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Intrinsiq Materials Ltd.

(21) Appl. No.: 11/996,572

(22) PCT Filed: Jul. 11, 2006
(86) PCT No.: PCT/GB06/02557

§ 371 Date: Jan. 23, 2008

(30) Foreign Application Priority Data
Jul. 23, 2005 (GB) 0515136.0

(51) Int. Cl. C01B 3/50; C01B 6/04

(52) U.S. Cl. 423/646; 423/658.2

(57) ABSTRACT

The invention relates to a reversible hydrogen storage composition comprising lithium hydride which desorbs hydrogen when heated in a hydrogen environment to a temperature of 470° C. or more to form a hydrogenated state, and absorbs hydrogen when cooled to 420° C. or less, the temperatures of absorption and desorption being independent of the pressure of the hydrogen environment. A partially processed blend of powdered lithium hydride and catalytic amounts of other elements such as Fe, B, Ni, Co or C, added as micron or sub-micron sized powders and still present in the blend as a pure phase, can provide improved hydrogen storage.

This invention relates to a method of making a hydrogen storage composition, a hydrogen storage composition, uses of a hydrogen storage composition, and methods of using a hydrogen storage composition, and is especially concerned with reversible hydrogen storage compositions.

Hydrogen is widely regarded as a promising alternative to conventional fuels such as carbon-based fuels. For example a number of major motor manufacturers are developing hydrogen powered vehicles using either fuel cells or hydrogen fuelled internal combustion engines. Conventional cylinder-stored hydrogen is unsuitable for a number of these new applications, and there is a desire to develop alternative hydrogen storage means. In particular there has been a desire to develop hydrogen storage materials that can reversibly store hydrogen, that is, materials that can be activated in some way to release hydrogen, and then treated to re-store hydrogen, and so on (i.e. “secondary” hydrides akin to a secondary battery). There is a particular need to develop hydrogen storage materials that are suitable for mobile storage applications, for example for use in the above mentioned hydrogen fuel-cell vehicles. For these applications high weight percent hydrogen content is desirable in a light storage medium. As an example it has been calculated that for automotive applications about 5.6 kg of hydrogen would be needed to replace an average tank of petrol to give a range of about 485 km (300 miles).

US2003/0113252 concerns a method of synthesizing an alkali metal hydride, for example, synthesising LiH using a mixture of lithium and carbon as starting materials. Once synthesised, hydrogen may be desorbed from LiH by heating or by hydrolysing the material with water [0020], the metal hydride thus being used in the normal manner as a “one-shot” (primary) hydride source.

EP 0902754 (McGill) describes the use of magnesium hydrides (either MgH₂ or Mg₂NiH₄) as materials for hydrogen storage and transportation. The magnesium hydrides described can be handled and stored at ambient temperature and pressure, and they can provide high hydrogen storage capacities (up to 7.6 wt % in MgH₂ for example). Desorption of hydrogen from these hydrides can be achieved by heating to about 360° C., but according to EP 0902754, this temperature can be reduced by 100° C.-200° C. by ball milling the hydride to a powder to accumulate so much strain and defects in the hydride that heat activated desorption of hydrogen is facilitated.

EP 1129027B (or WO 00/20328 to McGill) describes a lithium based hydrogen storage composition. The patent states that “lithium based hydrides have previously attracted only limited attention because of their unfavourable hydrogenation thermodynamics.” It also explains that “the hydrogen bond in lithium hydride is very strong”, and that “lithium hydride decomposes at temperatures higher than its melting point”, and “decomposes only at temperatures above 720° C.”. It makes the point that “until now (the date of the EP1129027 patent application) it (lithium hydride) has offered no prospects for reversible hydrogen storage”.

EP1129027 explains that (primary) hydrides such as Li Al H4 are not usable for reversible hydrogen storage because they cannot be re-hydrogenated under gaseous hydrogen. Thus, lithium-based hydrides have attracted only limited attention because they offered no prospects for reversible hydrogen storage.

EP 1129027 shows that lithium hydrides can be suitable for hydrogen storage if combined with a metal so as to form a complex hydride such as Li₅Be₃H₁₁ which reversibly hydrogenates, or if combined with metals or metalloids such as carbon, boron, silicon, phosphorus, zinc, manganese nickel, iron, chromium, copper, aluminium, calcium, sodium or potassium, which may react with the lithium in the desorbed state or form solid solutions with the lithium. The patent states the molar ratio of lithium to other element is between 7:1 and 1:2, depending on the phases that can be formed, and exemplifies a molar ratio between lithium hydride and other elements of 1:1. Hydrogen desorption is achieved according to EP1129027 in all cases at temperatures between 100° C. and 300° C.

We have discovered an alternative method for achieving a reversible hydrogen storage material based on lithium hydride, which dehydrogenates at more workable temperatures than the decomposition temperature of lithium hydride of 720° C. According to our invention this is achieved by heating the lithium hydride material up to a high temperature, typically one in excess of 450° C. or even above 470° C., e.g. to about 500° C., in a hydrogen environment, and preferably thermal cycling the material between the high temperature and a lower temperature, in the hydrogen environment.

A first aspect of the invention provides a method of making a hydrogen storage composition having a hydrogenated state from which hydrogen is liberated and a dehydrogenated state which absorbs hydrogen to produce said hydrogenated state, the method comprising (i) heating a composition comprising lithium hydride to a first temperature of at least 450° C., preferably at least 470° C., in a hydrogen environment, and (ii) subsequently cooling the composition to a second temperature of 420° C. or less, preferably 400° C. or less, in the said hydrogen environment, whereby hydrogen is absorbed into the lithium hydride as the temperature is lowered, absorption occurring in the temperature range between the said first and second temperature.

In a preferred method the cooled lithium hydride is then re-heated from the said second temperature to the said first temperature, whereby desorption of hydrogen occurs in the temperature range between the said first and second temperature.

Preferably the composition comprising lithium hydride is cycled between the said first and second temperatures several times. It may be cycled at least 3 times in total, preferably at least 5 times, more preferably at least 8, 10, 12 or even at least 15, 20 or 25 times in total. One cycle consists of heating to the said first (higher) temperature and cooling to the second (lower) temperature.

What is required is to heat the material though the critical temperature range to complete reaction. Conveniently the composition is heated to about 500° C. and cooled to about 300° C. to ensure optimum reaction is achieved.

We observe the material being activated and capable of reversible hydrogen storage from the first heating cycle. However, we have found that increasing the number of temperature cycles increases the amount of hydrogen which can be stored (absorbed) and subsequently released (desorbed) from the composition comprising lithium hydride. This can be referred to as “activation of” or “charging up” the material.

The first, higher temperature of the temperature cycling is much higher than that to which the lithium hydride based materials in EP1129027 are exposed.

Also the second lower temperature of 420° C. is well above the upper limit of the temperatures referred to in EP1129027 of 300° C.; hydrogen is desorbed according to EP1129027 at temperature between 100° C. and 300° C. in all cases.

During thermal cycling we observe that the temperatures of hydrogen absorption and desorption occur consistently at substantially the same respective temperatures for each cycle. More surprisingly, the respective temperatures of absorption and desorption of the hydrogen observed during the method according to the invention are substantially constant and unaffected by the hydrogen pressure. This is in contrast to what would conventionally be expected according to Van't Hoff's equation, by which in reactions involving gas generation, a lowering of the hydrogen pressure will lower the temperature required to dehydride the sample. This observed anomaly (i.e. failure to follow Van't Hoff's equation) is thought to be due to the processes by which the hydrogen is being absorbed and desorbed in the method according to the invention, and is explored in more detail later in the specification.

A composition comprising lithium hydride that behaves in this way is considered novel per se. Accordingly a second aspect of the present invention provides a reversible hydrogen storage composition comprising lithium hydride which desorbs hydrogen when heated in a hydrogen environment to a temperature of at least 450° C., preferably at least 470° C. to form a hydrogenated state and absorbs hydrogen when cooled to 420° C. or less, preferably 400° C. or less, the respective temperatures of absorption and desorption being substantially independent of the hydrogen pressure.

The present invention further provides the use of such compositions for hydrogen storage, and especially for reversible hydrogen storage, wherein they are used and re-used to store and release hydrogen numerous times, for example, in automotive applications, or to power fuel cells, etc.

Preferably the composition comprising lithium hydride comprises another element or two or more other elements in addition to the lithium hydride, for example an element or elements selected from the group consisting of iron, boron, nickel, cobalt and carbon. While compositions comprising any amount of other element(s) fall within the scope of the present invention, in preferred methods and compositions according to the invention, the composition preferably comprises at most 50 atomic percent of an other element or combination of other elements, more preferably it comprises at most 40 atomic percent of the other element(s), even more preferably at most 25 atomic percent, and for some embodiments at most 15 atomic percent of the other element(s), at most 10 atomic percent of the other element(s), or even about 5 atomic percent of the other element(s). We have found that small additions of other element(s), particularly iron or boron, can dramatically improve the ability of lithium hydride to store hydrogen in a reversible manner, when combined with the temperature cycling described above. We have found that small percentage additions of the other element(s) are sufficient to enhance the hydrogen charging process of the lithium hydride material, and that the larger amounts used in the examples in EP1129027 (which uses 1:1 molar ratios of LiH and other element) are not required. Indeed the compositions with smaller atomic percent added element(s) store hydrogen significantly more effectively than those with higher atomic percentages of added element(s). The small additions of other element(s) appear to enhance the activation process and increase the overall storage capacity of the compositions.

A composition as hereinbefore described comprising lithium hydride in combination with a relatively small amount of other element(s), suitable for use as a reversible hydrogen storage material is considered novel per se.

Accordingly a third aspect of the present invention provides a reversible hydrogen storage composition having a hydrogenated state from which hydrogen is desorbed and a dehydrogenated state which absorbs hydrogen to produce said hydrogenated state, characterised in that the dehydrogenated state is a composition comprising lithium hydride and one or more other elements chosen from the group consisting of boron, iron, nickel, carbon and cobalt which are present in total in an amount of less than 40 atomic percent, preferably less than 30 atomic percent, especially preferably less than 25 atomic percent, even less than 10 atomic percent for some elements (e.g. carbon) based on the total composition, and desorption and absorption occurs at a temperature in the range 420° C. and 450° C.

For the composition according to the third aspect of the invention, and compositions and methods according to all aspects of the invention, testing showed that the respective temperatures of hydrogen absorption and desorption are substantially independent of the hydrogen pressure.

The method according to the present invention comprises heating and cooling lithium hydride in a hydrogen environment. We have found, as mentioned above, that the pressure of hydrogen used is not critical. This is in contrast to prior art hydrogenation of hydrides which is usually achieved only with 99.999 atomic percent purity hydrogen. In the prior art it is usually observed that reversible hydrides become deactivated by any impurities in the hydrogen environments, for example any sulphur or oxygen in the environment poisoning the surface by reactivating with it and therefore preventing hydriding and dehydriding reactions taking place. We have observed that in our method and for our compositions, our composition can absorb hydrogen at low partial pressures, including at atmospheric pressure (0.1 MPa, 1 Bar) in an argon 5 atomic % hydrogen mixture (i.e. a 0.05 Bar hydrogen pressure). According to our invention hydrogen absorption and desorption can occur at a hydrogen pressure as low as 0.001 MPa (0.01 Bar), and, for example, hydrogen pressures as high as 3 to 4 MPa (30 to 40 Bar), although our methods and compositions do benefit from some increased pressure, with a range of 0.1-2.5 MPa (10-25 bar) being preferred for activating the material. Our method and compositions are able to absorb hydrogen at these relatively low hydrogen pressures because the reactions that are occurring do not follow Van't Hoff's equation.

The fact that our compositions and compositions made according to the method of the first aspect of the invention are, at least in preferred aspects, able to absorb hydrogen at low pressure means that an application for the compositions is in a method of purifying an impure hydrogen environment, i.e. absorbing hydrogen from an impure environment and then desorbing it in a controlled manner as pure hydrogen.

Accordingly a fourth aspect of the present invention provides a method of purifying an impure hydrogen environment, the method comprising:
(a) activating a composition comprising lithium hydride using the method according to the first aspect of the invention;
(b) desorbing the hydrogen from the activated composition; then
(c) positioning the activated and desorbed composition in the impure hydrogen environment and heating it to a temperature of 420° C. or less, preferably 400° C. or less, whereby hydrogen is absorbed into the lithium hydride from the impure hydrogen environment; and then
(d) heating the composition, in a new environment where purified hydrogen is to be delivered, to a temperature of at least 450° C., preferably at least 470° C. to desorb hydrogen into the new environment.

After desorption in step (b) in the absence of hydrogen the composition will easily absorb hydrogen on reheating. As a means to continuously purify a stream of hydrogen, the purification method can conveniently be achieved using a valved system on a hydride tank, connecting the impure gas stream on each absorption cycle (cooling) and connecting the tank to the new environment on the desorption cycle.

The above method comprises activating the composition to be used in the purification process initially. Alternatively, but less preferred the method of purifying may comprise activating the composition in the impure environment in the first place.

This purification method may conveniently be used, for example, to purify a hydrogen environment poisoned with moisture or oxygen.

Another advantage of the fact that our compositions do not follow Van't Hoff's equation is that they may be used to provide compressed hydrogen gas. Accordingly another aspect of the invention provides a method, of compressing hydrogen comprising:
(a) activating a composition comprising lithium hydride using the method according to the first aspect of the invention;
(b) desorbing the hydrogen from the activated composition; then
(c) positioning the activated and desorbed composition in a free-flowing hydrogen environment, and heating it to a temperature of 420° C. or less, preferably 400° C. or less, whereby hydrogen is absorbed into the lithium hydride from the free-flowing hydrogen environment; then
(d) heating the composition, in a sealed enclosure to a temperature of at least 450° C., preferably at least 470° C. to desorb hydrogen into the sealed enclosure.

This process can be repeated as necessary until the desired compression of hydrogen is achieved, for example using a valved system so that the free flowing hydrogen gas stream is connected to the hydride tank on each absorption cycle (cooling) and connecting the tank to a new environment where compressed hydrogen is desired on the desorption cycle.

The above method comprises activating the composition to be used in the hydrogen compression process initially. Alternatively, but less preferred the method of compressing hydrogen may comprise activating the composition in the free flowing hydrogen environment in the first place.

It is assumed that the composition comprising lithium hydride has inevitably been exposed to air, or moisture (this may be during storage, and/or once installed for use) so that, given the high reactivity of lithium hydride, it comprises at least a surface region of lithium hydroxide, or lithium oxide, or both. One skilled in the art would be aware of this automatic contamination. For the methods and compositions of the present invention we believe this at least partial surface layer of lithium oxide, or lithium hydroxide, or both is playing an important part in the behaviour of the lithium hydride. Presence of lithium hydroxide or lithium oxide (Li₂O) or both can be detected by X-ray diffraction techniques, and/or by well known surface analysis techniques.

Preferably the lithium hydride in the composition has a fine scale nano-sized structure. This may be achieved for example by introducing dislocations and other defects into a commercially available lithium hydride. This may be done, for example, by partial ball milling. While the structure is preferably nano-sized, the particle size of the lithium hydride is generally of the order of microns, typically less than 50 microns.

Preferably the particle size of the other element(s), in compositions and methods according to the invention, is less than 50 microns, preferably less than 15 microns or even less than 10 microns. This can be achieved from commercially available compositions, which typically have a larger particle size, by ball milling or other similar techniques. In general the finer the particle size the better, as it is believed that the other element(s) may be acting as a catalyst to the lithium hydride activation, and for optimum operation of a catalyst uniform distribution on surface of the lithium hydride particles is desirable. Ball milling is a suitable technique for distributing the catalyst uniformly and introducing a defect structure into the lithium hydride as is preferred.

Ball milling is a process which is commonly used in mechanical alloying processes. In mechanical alloying processes ball milling is used to combine material on an atomic scale. In preferred methods and compositions according to our invention, a ball milling technique is used to combine together the lithium hydride and the other element(s), but that ball milling process is ceased before mixing on an atomic scale is achieved.

The lithium hydride and the other element(s), if present, may be mixed together in the same ball mill chamber. We have found that preferably ball milling is controlled so that a finely divided mixture of lithium hydride with other element(s) (an “intimate mixture”) is achieved. Some of the other element(s) may be present in the matrix of the lithium hydride, but most will still be visible (by scanning electron microscope) as visible lumps, for example about 10 microns in size. The ball milling process is stopped before a solid solution of other element(s) in the lithium hydride matrix is formed, i.e. mixing on an atomic scale is not achieved or desired. The resulting composition is therefore a partially processed mixture of components. This can be detected by XRD techniques. In other words, substantially all the other element(s) e.g. at least 80%, preferably at least 90% of the other element(s) is present as a pure phase, with the remainder inevitably permeating with time into the lithium hydride matrix, so that the lithium hydride composition is essentially a pure composition as opposed to an intermetallic or solid solution.

A composition which has been treated in this way is believed to be novel per se. Accordingly another aspect of the present invention provides a reversible hydrogen storage composition having a hydrogenated state from which hydrogen is liberated and a dehydrogenated state which absorbs hydrogen to produce said hydrogenated state, characterised in that the dehydrogenated state comprises an intimate mixture of lithium hydride and one or more other elements chosen from the group consisting of boron, iron, nickel, cobalt and carbon, which are present in total in an amount of less than 50 atomic percent, preferably less than 40 atomic percent. By an “intimate mixture” we mean that the lithium hydride retains its integrity, and is not significantly permeated on an atomic scale with the other element. In other words the lithium hydride and the other element have not been mixed on an atomic scale to form an alloy, an intermetallic, or a solid solution.

The hydrogen storage composition, either with only lithium, or also with one or more of the other elements, is preferably ball milled or similarly mechanically worked to introduce nanoscale grain structures, and preferably no process control agents are used during milling, so as to avoid contamination. Where other elements are present, the components are only mixed using methods that result in a mixture that is only partially processed so that blending is incomplete, thereby producing the said intimate mixture.

If a composition comprises the preferred “intimate mixture” or “partially processed” microstructure, XRD traces will show peaks corresponding to the elements added (which peaks would disappear if complete mixing at an atomic scale took place). SEM photography may also help in this judgement. Both these analytical techniques will indicate the presence of substantially pure other element(s) in the intimately mixed composition. This is in contrast to the prior art lithium hydride compositions described in EP 1129027B (McGill).

Another aspect of the invention provides a method of making a precursor (i.e. unactivated) hydrogen storage composition capable of being activated with hydrogen according to the method of the first aspect of the invention, comprising mechanically grinding lithium hydride and one or more other elements sufficiently to form an intimate mixture but not so far as to form a solid solution, intermetallic compound or alloy. The processing is stopped and the partial blend removed from the equipment at this stage.

As an alternative source for the components of the composition, a plasma arc process may be used to produce fine scale nano-sized structures in lithium hydride, for example as described in EP1257376, EP 1415741 or EP 1398100.

It is also desirable to provide the other element(s) as nano-particles and particle sixes of less than 200 nm, and especially less than 100 nm, distributed through the lithium hydride can be expected to give good results. Nano-scale particles may be produced using any suitable method, for example by thermal processes including laser ablation, flame pyrolysis or plasma arc. Preferably, a plasma arc process is used to produce fine nano-scale powder of the other element, and the powders subsequently mixed together, preferably by ball-milling until a partially processed mixture is achieved. Powders produced according to the plasma arc process typically have a diameter of less than 200 nm. Alternatively, a combination of ball milling or other mechanical energy processes and a plasma arc process may be used.

Without limiting the invention in any way, it is thought that when cooled between the first and second temperatures in a hydrogen environment, the hydrogen initially dissociates at the surface of the lithium hydride according to reaction (I)

H₂→2H⁺ (I)

and then diffuses along grain boundaries or other defects in the lithium structure. Since the lithium hydride has inevitably been exposed to moisture containing air or other oxygen source it will inevitably have at least a partial surface coating of lithium hydroxide or lithium oxide, or both. It is thought that during the absorption process, some of the dissociated hydrogen ions react with lithium oxide to form lithium hydroxide, and other dissociated hydrogen ions move into interstitial sites in the lithium structure. Small amounts of other elements such as boron or iron act as catalysts to increase the dissociation of hydrogen gas to hydrogen ions and hence enhance the process. Also diffusion along grain boundaries is enhanced if the material has fine grain size, e.g. a nanostructure, thus processes that produce such a structure improve the absorption process. When reheated from the second to the first temperature according to preferred aspects of the method of the invention hydrogen desorbs at about 450° C. It is thought that this desorption results at least partly from a reaction of any lithium hydroxide in the composition, probably according to the following reaction:

LiOH+LiH⇄Li₂O+H_{2 (g)} (II)

Our results show that hydrogen is evolved in the temperature range 420° C. to 470° C., and typically around 450° C. regardless of the pressure of hydrogen above the lithium hydride sample. This is contrary to what is normally expected according to the Van't Hoff principle. It is thought that this is explained according to the present invention because lithium hydroxide melts in this temperature range and the equilibrium of the above reaction (II) is driven to the right when the lithium hydroxide melts. A reaction evolving gas which results from melting would not be expected to follow Van't Hoff's equation.

Our results showed our samples showing some melting at the hydrogen desorption temperatures, which is consistent with reaction II above.

As explained in more detail with reference to the examples later, DSC (differential scanning calorimetry) curves representing cycling according to our method typically show two peaks, one sharp melting peak at 420° C. followed by larger broader peak at about 450° C. It is thought these represent LiOH present melting (the 420° C. peak) and then acting in combination with LiH so that hydrogen is given off and Li₂O left as a residue (the 450° C. peak). Unreacted LiH is still present. As the material is activated and charges up, more of the LiH takes part in the reaction, possibly enhanced by the molten state of the LiOH accessing more of the LiH, and some LiH may convert into LiOH.

According to a preferred method according to the invention the lithium hydride is cycled between the first and second temperatures several times. Our results show that cycling increases activation of the material, i.e. more and more hydrogen is absorbed and desorbed on each cycle. It is thought that as the hydride is cycled more and more lithium hydride is being exposed and activated and more hydrogen can be desorbed each cycle. Indeed we have found that up to 8 weight percent and even up to 11 weight percent hydrogen can be absorbed and desorbed from the material.

### EXAMPLES

The examples are described with reference to the accompanying figures in which:

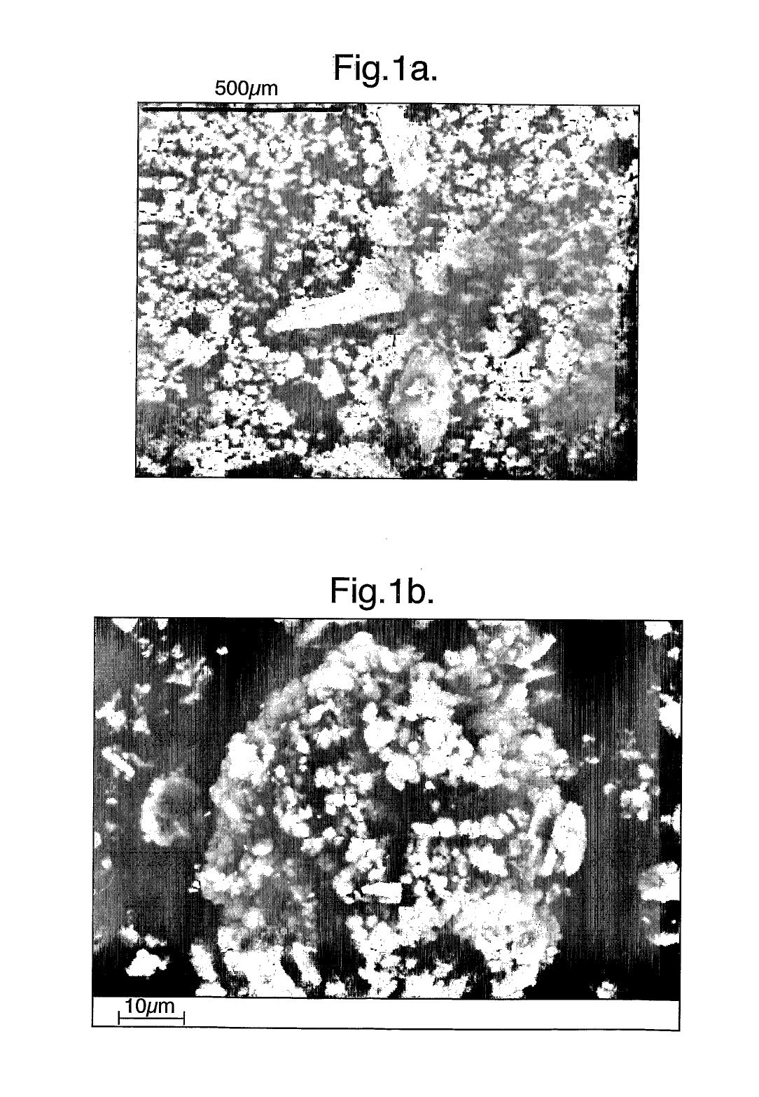

FIGS. 1a and 1b show SEM micrographs of compositions according to the invention;

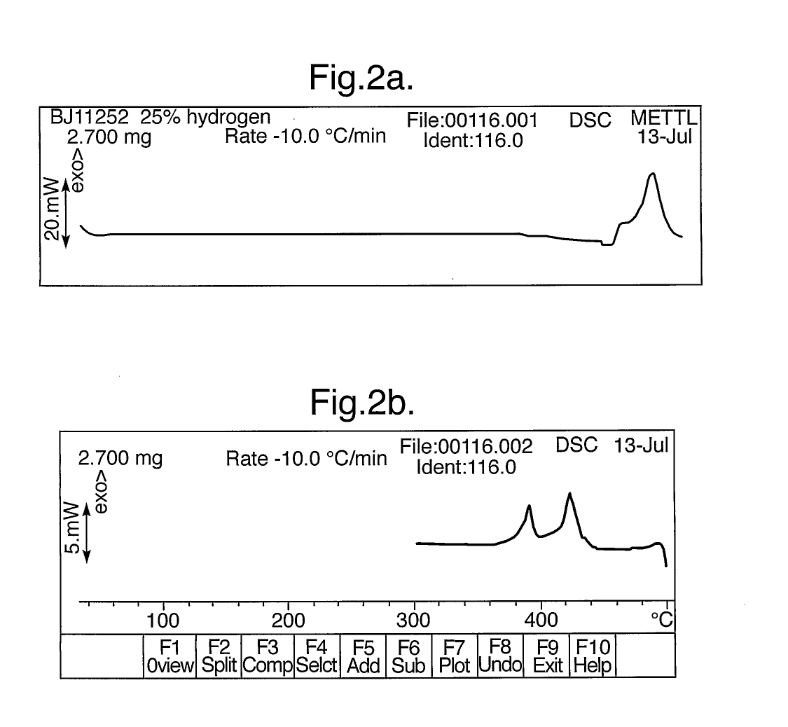

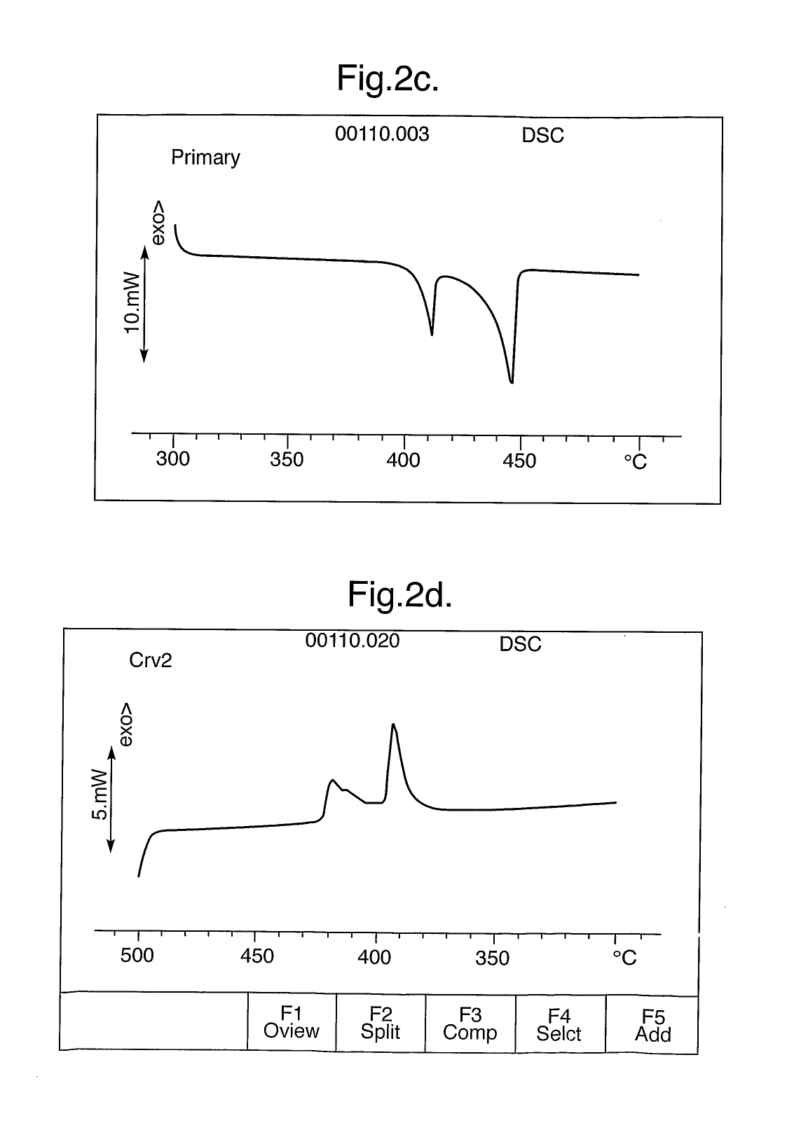

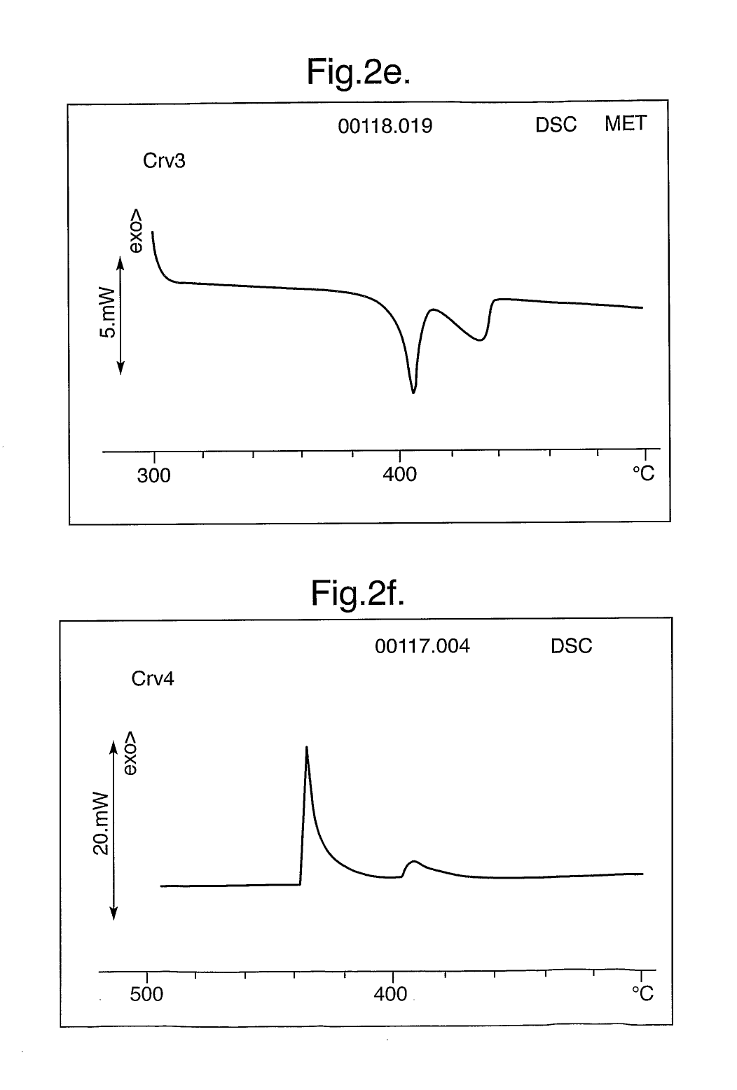

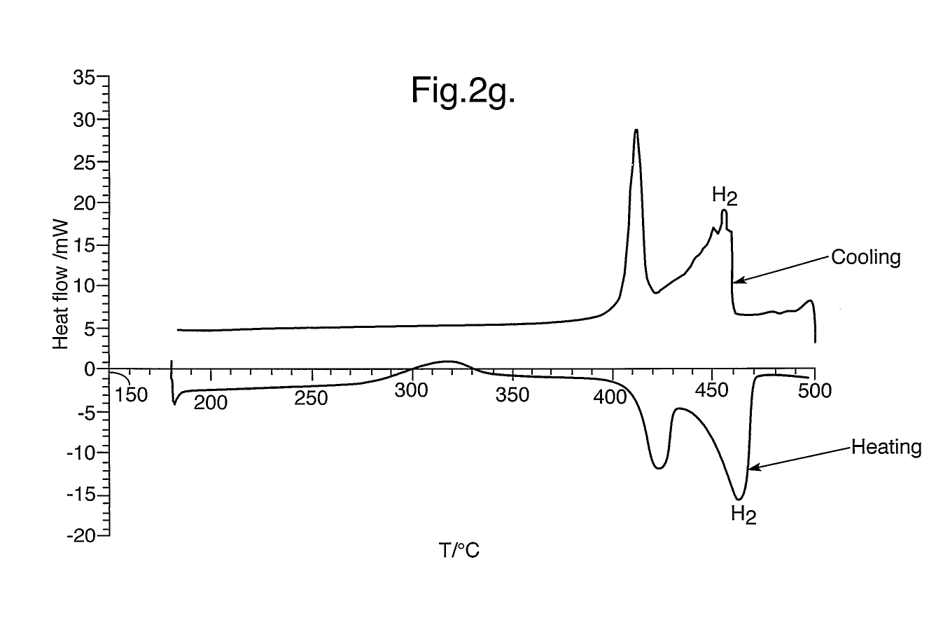

FIGS. 2a to 2f show DSC curves for sequential cycles during activation of a composition according to the invention;

FIG. 2g show a similar DSC curve for another composition according to the invention;

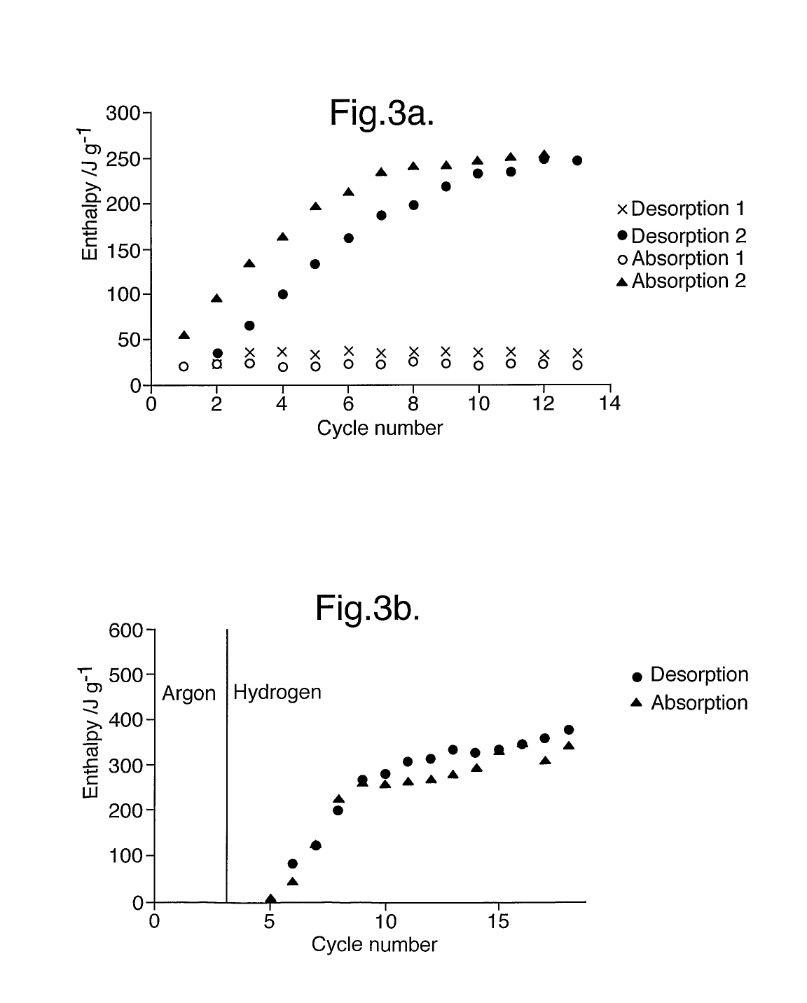

FIGS. 3a and 3b show enthalpy changes occurring during cycling of different compositions according to the invention;

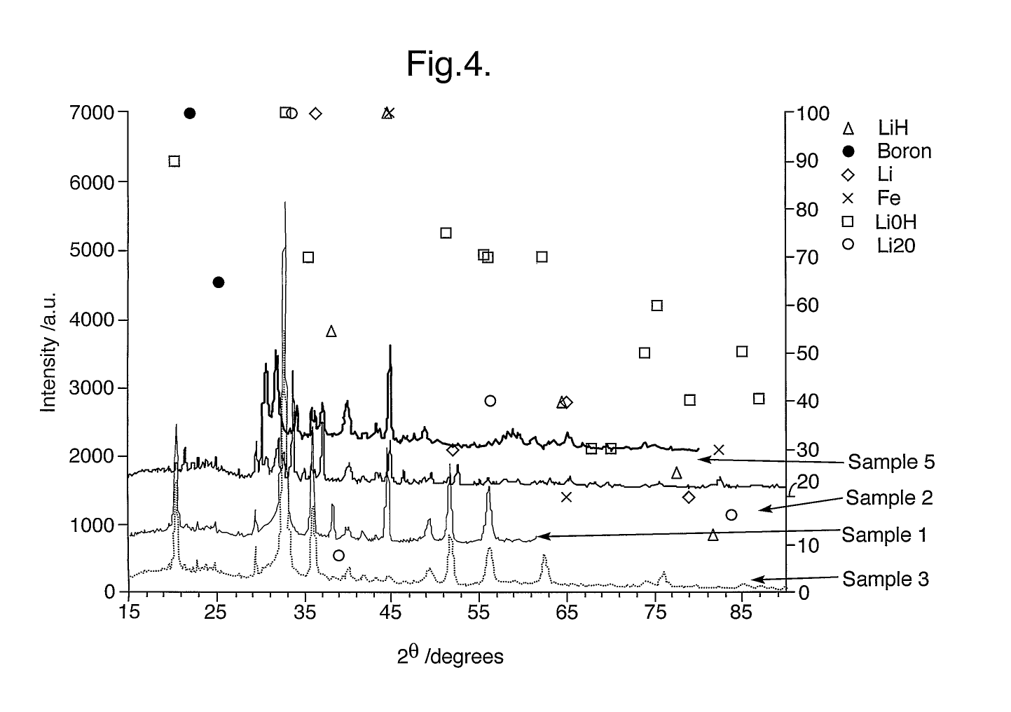

FIG. 4 shows XRD data for compositions according to the invention;

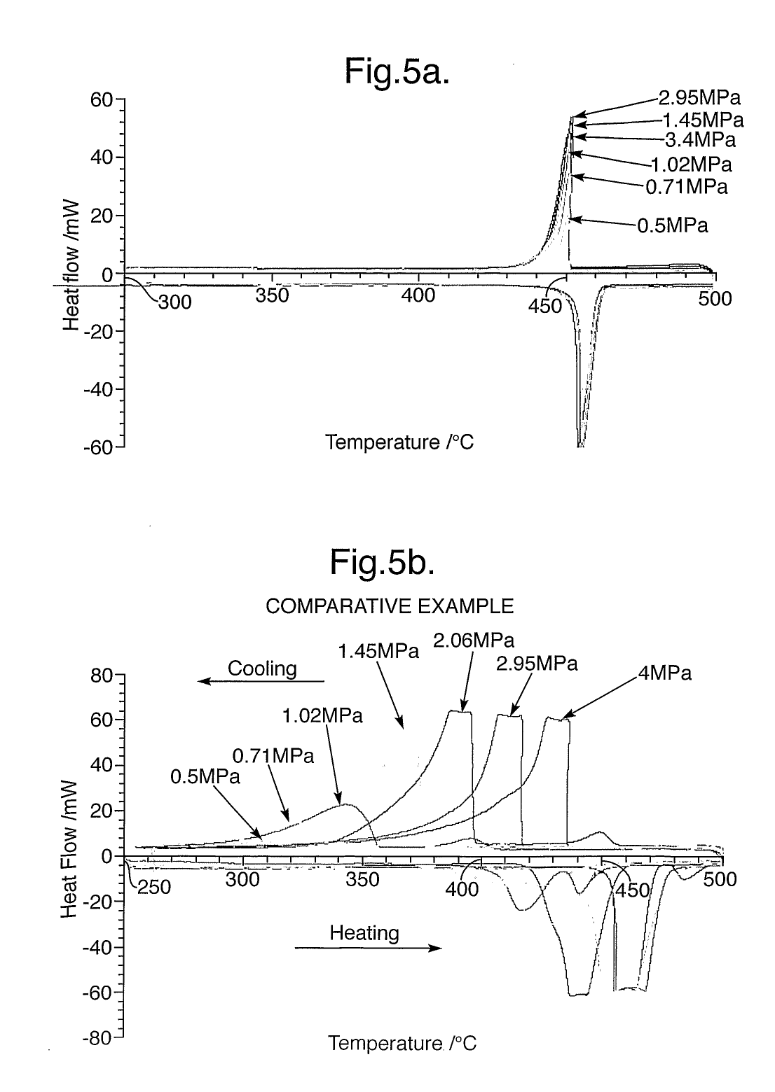

FIG. 5a shows DSC data for a composition according to the invention cycled in different hydrogen pressure environments; and

FIG. 5b shows DSC data for a comparative example similarly cycled in different hydrogen pressure environments.

Table 1 shows feedstock materials that were used in the examples. All samples are compositions according to the invention and/or compositions that can be used in the method of the invention.

TABLE 1

| Sample | |
|---|---|
| No | Atomic % analysis for final milled composition |
| 1 | LiH |
| 2 | LiH, 5 at % Fe |
| 3 | LiH, 15 at % B, 2 at % Fe |
| 4 | LiH, 50 atomic % B |
| 5 | LiH 50 atomic % Fe |

Starting components were sourced as follows:
LiH = Lithium hydride powder (as supplied by Alpha, 98% pure) in all samples
Fe = iron powder (<325 mesh, 99.9% metals as supplied by Alpha)
B = boron crystalline pieces as supplied by Johnson Matthey

For each of the samples, the lithium hydride powder and any other components (where used) were placed in the milling pot of a Fritsch Pulverisette planetary ball mill in appropriate amounts to achieve the resultant atomic percent mixture shown in the table. Before the addition of the starting materials hardened chrome-steel balls were placed in the milling pots. Ball milling is a process which impart a large amount of mechanical energy into a material. If carried to completion ball milling is an effective mechanical alloying technique for combining materials on an atomic scale; the components reposition their atomic positions in an alloy structure or in an intermetallic form or a solid solution form. According to our examples the ball milling process is stopped (i.e. there is only partial processing) before such atomic scale repositioning of the components is achieved. Consequently our resultant compositions are a intimate mixture of the components on a nano scale with some larger particles of one component still evident having at least one dimension of the order of at least 10 microns, and for some materials at least 50, or even 100 microns or 200 microns. Total ball milling times for each sample are in the range 12 to 24 hours.

Scanning electron microscope pictures were taken of the resultant powder to observe the distribution of the components.

X ray diffraction analysis was also performed on the resultant milled power samples using copper radiation at 40 kV, 40 mA.

FIG. 1a shows an SEM micrograph of sample number 4 after ball milling for 24 hours. The micrograph shows large irregular shaped particles. These are pieces of boron that have survived the milling process. These are irregular in shape, their longest dimension being of the order of 200-300 microns (see micrograph). The matrix lithium hydride powder is very fine, having a particle size typically less than 50 microns (see micrograph). XRD analysis of sample 4 (not illustrated) corresponds with the SEM analysis and shows a boron peak. Thus in the ball milling process for sample 4 the boron has not been alloyed with the lithium hydride, nor gone into solid solution with the lithium hydride.

Similarly FIG. 1b shows a SEM micrograph of sample number 2 (LiH 5 at % Fe) after ball milling. In the micrograph can be seen grey agglomerated lithium hydride particles, with smaller white particles of iron contrasted against the lithium hydride. Other parts of the same sample (not illustrated) showed a finer distribution of grey lithium hydride, again with white iron particles visible on them. The agglomeration of the lithium hydride during ball milling may automatically result in cessation of the ball milling process at the desired stage, i.e. prior to formation of a solid solution, so that the added other element is still in substantially pure form in the post-milled composition.

After testing each sample was then temperature cycled according to the method of the present invention to load it with hydrogen. Cycling was carried out using a high pressure differential scanning calorimeter (HP-DSC) and DSC curves taken for each sample over the various cycles to examine the hydrogen absorption and desorption. The HP-DSC used was a Mettler-Toledo DSC HP27. Tantalum pans were used for the sample and reference in the DSC. A known weight of each sample was loaded in the HP-DSC. The system was flushed with nitrogen to remove any oxygen and check for leaks, and then hydrogen (Air Products 99.9995%) was introduced. The system was flushed with hydrogen and then the system pressurised to 1.75 MPa (17.5 bar hydrogen). An initial heating from ambient to 500° C. was started with a heating rate of 10° C. per minute. Then the sample was cooled from 500° C. to 300° C. at the same rate. From then on continuous thermal cycling between 300° C. to 500° C. was performed. In both the heating and cooling stages, the heat flow, corresponding to hydrogen desorption and absorption as well as to other events leading to a change in the enthalpy of the sample, was recorded.

After cycling some melting of the samples was observed to have taken place.

After cycling each sample was scraped from the DSC pan into a TGA (thermo gravimetric analysis) pan for determination of hydrogen content by measuring the weight loss that occurs on heating under flowing Argon. TGA analysis was performed using a Perkin Elmer TGA7

For sample number 3 (LiH, 15 atomic % B, 2 atomic % Fe), FIGS. 2a to 2f show the DSC traces (enthalpy of system vs temperature) for the initial heating from ambient, to 500° C. (FIG. 2a), the first cooling from 500 to 300° C. (FIG. 2b), and then subsequent heating/cooling/heating/cooling cycles between 300 and 500° C. (FIGS. 2c, 2d, 2e, 2f respectively).

Enthalpy peaks on a DSC curve indicate an exothermic (upward peak) or endothermic (downward trough) change in the system. Typically sharp narrow temperature range peaks or troughs represent a phase change such as melting (endothermic) whereas broader peaks or troughs indicate gas absorption (exothermic) or desorption (endothermic) or a chemical reaction such as oxidation (exothermic).

Considering FIG. 2a, the first heating from ambient, to 500° C. shows an exothermic peak at about 450° C. This is thought to be due to some sort of oxidation reaction or recovery of the structure on heating. Considering FIG. 2b, the first cooling from 500° C. to 300° C. shows two exothermic peaks; a larger one at about 420° C. and a smaller one at about 390° C. One or both of these are thought to represent hydrogen absorption. When absorption occurs it is though that hydrogen gas dissociates at the sample surface, diffusing along grain boundaries and other defects in the fine structure. The dissociated hydrogen ions may then bond electrochemically with lithium, or form lithium hydroxide from any lithium oxide which may be present in the sample due to exposure to air. FIG. 2c shows the next heating; this time it is from 300° C. to 500° C. Two endothermic troughs are seen at 420° C. and 450° C. The first of these peaks is thought to be caused at least partly by melting of lithium hydroxide, and the second higher temperature peak to result at least partly from hydrogen desorption. Any lithium hydroxide present may have formed during the first cooling process or be present initially. Melting of lithium hydroxide is thought to bias reaction II (LiOH+LiH⇄Li₂O+H_{2 (g)}) to the right at about 450° C., resulting in desorption of hydrogen. FIGS. 2d-2f show DSC curves for subsequent cycles and show that the peaks and troughs repeat at the same respective temperatures each cycle.

FIG. 2g shows the signature DSC curve for sample 5 (LiH, 50 atomic percent iron). This figure shows again that the characteristic peaks occur at about 420° C. and 450° C.

Sample 3 (LiH, 15 atomic % B, 2 atomic % Fe) was run over 25 cycles and FIG. 3a plots the enthalpy change per cycle for the first 15 cycles. As can be seen in the figure the enthalpy measurements for the 450° C. peaks and troughs (which are predominantly mediated by hydrogen absorption and desorption and are indicated as “absorption 2” and “desorption 2” in the Figure) continued to grow in intensity for each cycle up to about 12 cycles. The sample was therefore fully charged or activated after 12 cycles. In contrast as can also be seen from the figure, the enthalpy for the 420° C. peaks and troughs (which are indicated on the figure as “absorption and desorption 1” and are predominantly dominated by a melting and freezing change of lithium hydroxide), does not increase substantially in value with increasing numbers of cycles.

FIG. 3b shows a similar curve to FIG. 3a, but is for sample number 1 (LiH). DSC curves on all other samples tested at 17.5 bar pressure behave in a similar way and gave enthalpy changes consistently at about 420° C. and 450° C., similarly rising in value with cycling. This enthalpy rise with cycling represents the sample being “activated”, i.e. “charging up” with hydrogen. Increasing amounts of sample are “exposed” due to the hydrogen absorption and desorption process occurring and more and more lithium hydroxide is exposed, leading to more reaction.

TGA analysis was performed on some of the samples after the temperature cycling process, when fully loaded with hydrogen, in order to measure the weight loss occurring as a result of the hydrogen desorption process. Results are shown in Table 2. Tᵢₙᵢ in the table is the onset temperature for the start of the weight loss event in the TGA. For the “charged samples tested this was at 425° C. This temperature is consistent with the thermal signatures of the DSC curves and supports the inference that a gas, presumably hydrogen, is being desorbed from the samples leading to a weight loss. This weight loss represents the hydrogen storage capacity for the sample. Table 2 also shows the enthalpy peak temperatures for each sample.

TABLE 2

| | | | No. of | Temp of |
|---|---|---|---|---|
| | % wt | No. of | entropy | enthalpy peaks |
| Sample No | loss | cycles | peaks | ° C. |
| 1 (LiH) | 3.9 | 17 | 1 | 460 |
| 2 (LiH, 5 at % Fe) | 8.6 | 3* | 2 | 420, 450 |
| 3 (LiH, 15 at % B, | 11.2 | 25 | 2 | 420, 450 |
| 2 at % Fe) | | | | |
| 4 (LiH, 50 at % B) | 3.5 | 17 | 2 | 420, 460 |
| 5 (LiH, 50 at % Fe) | 2.1 | 6 | 2 | 425, 465 |

*cycling stopped after 3 cycles because . . . DSC destroyed by reactive sample

Comparison of the samples shows that best results are achieved using small quantities of additives, and not stoichometric amounts as are present in samples 4 and 5. Best percentage hydrogen storage is achieved by sample 3 (LiH, 15 at % B, 2 at Fe). This shows a hydrogen storage capacity of over 11 weight percent. This is higher than any metal hydride storage system currently in the prior art.

Sample number 1 of lithium hydride showed only one temperature peak for the particular sample used for which a weight loss was measured. Later DSC investigations on subsequent samples of lithium hydride however did show the same characteristic two peaks as the other samples, as expected.

The samples were also subjected to analysis by the technique of TPD (Temperature programmed desorption) linked to a mass spectrometer. This procedure confirmed that it was indeed hydrogen that was being evolved. The working pressure for all samples was maintained in the range 1.9-2.1×10⁻⁷ torr. Significant hydrogen loss was observed at temperatures of 420° C. upwards.

XRD analysis was also performed on samples 1, 2, 3, and 5 in their “as received” state. Results are shown in FIG. 4. The figure also shows the expected position for Li, Li₂O, LiOH, B and Fe. Peaks for all of these are evident, indicating at least some initial content of Li₂O in the samples, which can react to form lithium hydroxide during hydrogen absorption, and the presence of initial lithium hydroxide in the pre-hydrided samples. This is thought to contribute to the high hydrogen desorption values achieved at 450° C. according to formula II (LiOH+LiH⇄Li₂O+H_{2 (g)}). Lithium hydroxide melts at 460° C.-470° C., and it is thought that when the sample is heated melting of the lithium hydroxide biases reaction II to the right, thereby releasing hydrogen. The Figures also show the presence of boron and iron (as appropriate) showing those materials have remained in their substantially pure elemental form and not mixed at an atomic scale to form either a solid solution or an intermetallic with the LiH. This accords with the SEM date shown in FIG. 1.

To support further the inference that hydrogen desorption and re-absorption is responsible for the DSC thermal signatures during cycling, a sample of type I i.e. lithium hydride was cycled in hydrogen, and another piece was cycled in argon. Pressure values and other conditions were as in previous DSC measurements by with hydrogen replaced by argon. When cycled in hydrogen the lithium hydride shows two peaks at 420° C. and 450° C., at least the higher temperature peak rising with cycling, i.e. the material is charging when cycled in hydrogen. When cycled in argon the DSC curves show an initial two peaks at 410° C. and 450° C. on first heating these peaks decreasing in intensity with increasing number of cycles. This is thought to represent the sample discharging its initially stored hydrogen, but being unable to recharge (since the atmosphere is inert argon). This provides further evidence that hydrogen absorption and desorption is occurring.

As noted above best results were achieved with sample 3 (LiH, 15 at % B, 2 at % Fe). It is thought that the added elements may act as a catalyst to enhance movement of dissociated H⁺ ions along grain boundaries. Also it is thought that the presence of lithium hydroxide in the sample initially, and formed during the hydrogen storage process, may cause a reaction at 450° C., which generates hydrogen according to reaction II (LiOH+LiH⇄Li₂O+H_{2 (g)}) at a consistent temperature of 450° C. regardless of the ambient pressure.

For lithium hydride with no other element(s) a comparison was made between the hydrogen storage of material as supplied by Alpha (see table 1) and the same sample after subjecting it to ball milling. Our results showed that the ball milled sample had improved hydrogen storage compared with the non ball milled sample. Both the as supplied lithium hydride sample and the ball milled sample appeared to have a micron particle size, but the ball milled sample had more nano structure in terms of defects introduced. Thus, the use of mechanically worked (colloquially known as “mechanically alloyed”) substantially pure LiH, in which submicron scale grain structure has been introduced, is preferred.

The samples were tested to see whether the pressure of hydrogen affected the DSC signatures. Cycling under the earlier specified conditions was performed at 5, 7.1, 10.2, 14.5, 29.5 and 34 bar hydrogen. For sample 3 (LiH, 15 at % B, 2 at % Fe), table 3 shows the temperature and intensity of enthalpy peaks, and FIG. 5a shows the results graphically.

TABLE 3

| Pressure/bar | ΔH/Jg⁻¹ | Tₚₑₐₖ/° C. |
|---|---|---|
| 34.6 | 484 | 451 |
| 29.5 | 504 | 452 |
| 14.5 | 485 | 452 |
| 10.2 | 442 | 451 |
| 7.1 | 359 | 451 |
| 5 | 252 | 451 |

According to Van't Hoff's theory one would expect to see a decrease in absorption and desorption temperature with pressure reduction. However this was not observed, the peaks occurring consistently at about 450° C. A similar consistent temperature of enthalpy peak with variation in pressure was achieved for several other samples. In particular a lithium hydride sample with no added other element(s) were found to activate or charge up in low pressures of hydrogen at 450° C., indicating that Van't Hoff does not apply.

For comparison, FIG. 5b shows the variation in enthalpy temperature peaks for a magnesium hydride alloyed by ball milling with 50 atomic percent cobalt for 12 hours under the same conditions as for the samples of the invention. The magnesium/cobalt composition obeys the Van't Hoff principle, with the temperature of hydrogen desorption occurring at a lower temperature with reduced hydrogen pressure.

In summary, the invention provides a reversible hydrogen storage composition comprising lithium hydride which desorbs hydrogen when heated in a hydrogen rich environment to a temperature of 470° C. or more to form a hydrogenated state, and absorbs hydrogen when cooled to 420° C. or less, the temperatures of absorption and desorption being independent of Van't Hoff. To improve hydrogen storage, the composition may be worked to produce a micron-scale or nano-scale defect structure in the LiH. The highest hydrogen storage was achieved using a partially processed blend of powdered lithium hydride and catalytic amounts of other elements such as Fe, B, Ni, Co or C, added as micron or sub-micron sized powders, and still present in the blend substantially as a pure phase.

1. A method of malting a hydrogen storage composition having a hydrogenated state from which hydrogen is liberated and a dehydrogenated state which absorbs hydrogen to produce said hydrogenated state, the method comprising activating a composition comprising lithium hydride by (i) heating the composition to a first temperature of at least 450° C., preferably at least 470° C., in a hydrogen environment, and (ii) subsequently cooling to a second temperature of 420° C. or less, preferably 400° C. or less, whereby hydrogen is absorbed into the lithium hydride as the temperature is lowered, absorption occurring in the temperature range between the said first and second temperatures.

2. A method according to claim 1 comprising the further step of re-heating the cooled composition to the said first temperature, whereby hydrogen is desorbed in the temperature range between the said first and second temperatures.

3. A method according to claim 2, comprising cycling the composition between the said first and second temperatures at least 3 times.

4. A method according to claim 1, wherein the composition comprises at most 50 atomic percent of an other element where only one other element is included in the composition, or a combined total of at most 50 atomic percent of two or more other elements, where two or more other elements are included in the composition.

5. A method according to claim 4, wherein the other element or elements are selected from boron, iron, nickel, cobalt and carbon.

6. A method according to claim 1 wherein the hydrogen environment is at a hydrogen pressure in the range 0.1 to 2.5 MPa (1 to 25 bars).

7. A method according to claim 2, wherein the respective temperatures of absorption and desorption of the hydrogen are unaffected by the pressure.

8. A method according to claim 1 wherein the lithium hydride has a nano-sized structure.

9. A method according to claim 4, wherein the particle size of the other element (s) is less than 50 microns.

10. A method according to claim 4, wherein the composition comprises an intimate mixture of lithium hydride and the one or more other elements.

11. An activated hydrogen storage composition made by a method according to claim 1.

12. A reversible hydrogen storage composition comprising lithium hydride which desorbs hydrogen when heated in a hydrogen environment to a temperature of at least 450° C., preferably at least 470° C., to form a dehydrogenated state, and absorbs hydrogen when cooled to 420° C. or less, preferably 400° C. or less, the respective temperatures of absorption and desorption being independent of the pressure of the hydrogen environment.

13. A composition according to claim 12, wherein the dehydrogenated state comprises an intimate mixture of lithium hydride and one or more other elements chosen from the group consisting of boron, iron, nickel, cobalt and carbon.

14. A reversible hydrogen storage composition having a hydrogenated state from which hydrogen is desorbed and a dehydrogenated state which absorbs hydrogen to produce said hydrogenated state, characterised in that the dehydrogenated state is a composition comprising lithium hydride and one or more other elements chosen from the group consisting of boron, iron, nickel, carbon and cobalt which are present in total in an amount of less than 50 atomic percent, and desorption and absorption occurs at a temperature in the range 400-470° C.

15. A composition according to claim 14, wherein the dehydrogenated state comprises an intimate mixture of lithium hydride and the one or more other elements.

16. A reversible hydrogen storage composition having a hydrogenated state from which hydrogen is liberated and a dehydrogenated state which absorbs hydrogen to produce said hydrogenated state, characterised in that the dehydrogenated state comprises an intimate mixture of lithium hydride and one or more other elements chosen from the group consisting of boron, iron, nickel, cobalt and carbon.

17. A composition according to claim 16, wherein the other element(s) are present in total in an amount of less than 50 atomic percent.

18. A composition according to claim 14, which desorbs hydrogen when heated in a hydrogen environment to a temperature of at least 450° C. preferably a least 470° C., to form a dehydrogenated state, and absorbs hydrogen when cooled to 420° C. or less, preferably 400° C. or less, the respective temperatures of absorption and desorption being independent of the pressure of the hydrogen environment.

19. A composition according to claim 13, wherein the particle size of the other element(s) is less than 50 microns.

20. A composition according to claim 13, wherein the particle size of the other element(s) is less than 200 nm.

21. A composition according to any of claims 12 to 20, wherein the average particle size of the lithium hydride in the composition is less than 200 nm.

22. A method of making a precursor hydrogen storage composition capable of being hydrogenated by activation with hydrogen according to the method of any of claims 1 to 10, comprising mechanically grinding lithium hydride and one or more other elements sufficiently to form an intimate mixture but not so far as to form a solid solution, intermetallic compound or alloy.

23. A method of purifying an impure hydrogen environment, the method comprising:
(a) activating a composition comprising lithium hydride using the method according to claim 1;
(b) desorbing the hydrogen from the activated composition; then
(c) positioning the activated and desorbed composition in the impure hydrogen environment and heating it to a temperature of 420° C. or less, preferably 400° C. or less, whereby hydrogen is absorbed into the lithium hydride from the impure hydrogen environment; and then
(d) heating the composition, in a new environment where purified hydrogen is to be delivered, to a temperature of at least 450° C., preferably at least 470° C. to desorb hydrogen into the new environment.

24. Use of an activated composition made by a method according to claim 1, or a composition according claims, for hydrogen storage, especially reversible hydrogen storage.

25. An activated hydrogen storage composition made by a method according to claim 1, or a composition according to claim 11, in a sealed vessel.

26. A method of compressing hydrogen comprising:
(a) activating a composition comprising lithium hydride using the method according to claim 1;
(b) desorbing the hydrogen from the activated composition; then
(c) positioning the activated and desorbed composition in a free-flowing hydrogen environment, and heating it to a temperature of 420° C. or less, preferably 400° C. or less, whereby hydrogen is absorbed into the lithium hydride from the free-flowing hydrogen environment; then
(d) heating the composition, in a sealed enclosure to a temperature of at least 450° C., preferably at least 470° C. to desorb hydrogen into the sealed enclosure.

27. (canceled)
